(19) United States
(12) Patent Application Publication
(10) Pub. No.: US 2009/0194468 A1
(43) Pub. Date: Aug. 6, 2009

(54) DEVICE FOR THE AUTOMATIC RECOGNITION AND SORTING OF GARMENTS

(76) Inventor: Enrico Maria Santicchi, Perugia (IT)

Correspondence Address: MANNAVA & KANG, P.C., 11240 WAPLES MILL ROAD, Suite 300, FAIRFAX, VA, 22030, US

(21) Appl. No.: 12/366,236

(22) Filed: Feb. 5, 2009

(30) Foreign Application Priority Data
Feb. 5, 2008 (IT) UD 2008 A 000021

(51) Int. Cl. B07C 5/34; B65G 19/18

(52) U.S. Cl. 209/576; 198/735.3

(57) ABSTRACT

A device for the automatic recognition and sorting of garments comprises: identification elements associated with the garments; a container to collect at least one of the garments; recognition elements able to recognize the identification elements; movement elements able to transport the garments from the container toward subsequent working steps. The device also comprises mobile contrast elements able to cooperate with the garments so as to keep the garments associated with the movement elements.

### FIELD OF THE INVENTION

The present invention concerns a device for the automatic recognition and sorting of garments intended to be sent toward any working step.

In particular, the device is employed in structures such as laundries, hospitals, factories, colleges, hotels or similar structures, in order to automatically recognize and sort garments, such as for example hospital uniforms, work overalls and other similar garments, or items of laundry, which have to be treated.

### BACKGROUND OF THE INVENTION

A device is known for the automatic recognition and sorting of garments, such as hospital uniforms, work overalls and other similar garments, which comprises a recognition chamber, provided with recognition means able to recognize an identification device with which the garment is provided, for example a TAG RFID, or bar code, in order to identify the presence of the garment inside the chamber. The recognition chamber of the known device also comprises at the upper part a wide aperture associated with a conveyor pipe, and at the lower part comprises a wall with a grill, associated with a powerful ventilator. The latter is able to deliver a powerful jet of air to impart to the garments contained in the recognition chamber a thrust upward, so that they exit from the upper aperture of the chamber, pass through the conveyor pipe and then reach the exit of the latter so as to be sorted toward the subsequent working steps.

One disadvantage of the known device is that it is bulky, due to the presence of the pipes that have to have a wide enough section to enable the garments to pass easily, and also due to the presence of the ventilator. The known device also needs installation operations that are inconvenient, it causes high energy consumption due to the activation of the powerful ventilator, and entails high production times and cost.

Purpose of the present invention is to produce a device for the automatic recognition and sorting of garments that entails a limited bulk, that is easy to install, that does not cause high energy consumption and entails limited production times and cost.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a device for the automatic recognition and sorting of garments comprises: identification elements associated with the garments, for example TAG RFID, bar codes or others, a container to collect at least one of the garments; recognition means able to recognize the identification elements; and movement means able to transport the garments from the container toward subsequent working steps.

According to a characteristic feature of the present invention, the device also comprises mobile contrast means able to cooperate with the garments so as to keep them associated with the movement means.

According to an advantageous feature of the present invention, the device also comprises expulsion means, associated with the mobile contrast means, able to allow to remove the garments from the movement means.

Advantageously the device comprises elastic means associated with the movement means and the mobile contrast means, able to influence the latter elastically so as to allow movement.

According to another advantageous feature of the present invention, the device comprises thruster means associated with the container, able to thrust the garments between the movement means and the mobile contrast means.

Advantageously the movement means comprises a conveyor belt, and the mobile contrast means comprises one or more panels.

According to a preferential but not restrictive solution of the present invention, the conveyor belt is disposed vertically with respect to the container.

The conveyor belt is therefore provided with a surface having sufficient adherence, able to prevent the garment comprised between the panel and the belt from slipping downward.

In this way, the device is not very bulky, allows a considerable saving in space, and is easily installed.

Advantageously, the expulsion means comprises one or more doors, pivoted on the panels.

According to another advantageous characteristic of the present invention, the device comprises actuation means, able to command the doors both to open and to close, so as to allow respectively the garments to exit from the vise that is created between the conveyor belt and the panel/panels, or to keep the garments close to the belt in correspondence with the door, so as to allow the transportation of the garments to continue to subsequent working steps.

In this way, the device does not entail high energy costs, and furthermore the times and costs of production and of maintenance of the device are considerably limited.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic representation of a device according to the present invention;

FIG. 2 is a schematic representation of a first operating condition of the device in FIG. 1;

FIG. 3 is a schematic representation of a second operating condition of the device in FIG. 1;

FIG. 4 is a schematic representation of a third operating condition of the device in FIG. 1;

FIG. 5 is a schematic representation of a fourth operating condition of the device in FIG. 1;

FIG. 6 is a schematic representation of a first variant of the device in FIG. 1;

FIG. 7 is a schematic representation of a second variant of the device in FIG. 1;

FIG. 8 is a schematic representation of a third variant of the device in FIG. 1;

FIG. 9 is a schematic three-dimensional representation of a detail of a fourth variant of the device in FIG. 1.

### DETAILED DESCRIPTION OF A PREFERENTIAL FORM OF EMBODIMENT

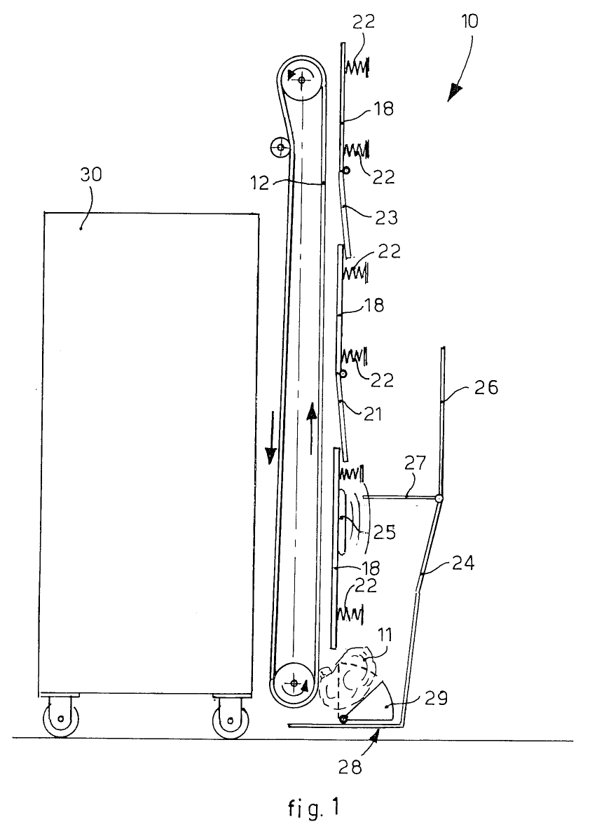

With reference to FIG. 1, a device 10 according to the present invention for the automatic recognition and sorting of garments 11, such as for example hospital uniforms, work overalls and other similar garments, each provided with a recognition tag, or a recognition chip or any other identification element, comprises a conveyor belt 12.

The conveyor belt 12, disposed vertically inside a frame, not shown in the drawings, is provided with a sufficiently adherent surface and is able to transport said garments 11.

The device 10 also comprises support elements, of a known type, able to be attached to the frame, and able to support panels 18, substantially rectangular in shape and having a width substantially equal to the width of the conveyor belt 12.

The panels 18 are also attached to the frame by means of movement means 22, also of the return type, such as for example springs, pistons, mechanical arms or other similar means. These are able to influence the panels 18 elastically so as to allow them to slide in the direction perpendicular to the direction of movement of the conveyor belt 12, that is, to allow the panels 18 to be moved close to/distanced from the conveyor belt 12.

The panels 18 are separated by expulsion doors 21, 23, with a substantially rectangular shape, having a width equal to the width of the panels 18 and a length equal to the distance between one panel 18 and the next, pivoted to the ends of said panels 18 by means of known pivoting elements. The expulsion doors 21, 23, commanded by known actuation means, determine in a closed condition a continuous surface between one panel 18 and the next. Vice versa, the expulsion doors 21, 23 are able to open upward, interrupting the continuity between the panels 18.

The device 10 also comprises a container 24, substantially parallelepiped, having a width equal to the width of the conveyor belt 12, able to contain said garments.

The container 24 is disposed at the base of the frame and is attached to the latter in such a manner that a portion of the combination of the conveyor belt 12 and the panel 18 constitutes one side thereof.

The container 24 is provided inside with a reading device 25, able to detect the presence of the identification elements associated with each garment.

The container 24 is also provided with an inlet door 26 and a feed door 27, associated with the upper part of the container 24 and pivoted to each other.

The inlet door 26, normally disposed in a position perpendicular to the support plane 28 of the container 24, otherwise called closed position, is able to be opened to allow to introduce the garments 11 inside the container 24. The closure of the inlet door 26 is effected by means of mobile means, also of the return type, such as for example springs, pistons, mechanical arms or other similar means, and is ensured by means of an automatic safety device, not shown in the drawings. In particular, the garments 11 are able to be disposed beforehand on the feed door 27, which functions as a shelf, disposed in a position parallel to the support plane 28 of the container, otherwise called horizontal position, so as to close the container 24.

The feed door 27, in the open position, is instead able to allow the garment 11 to slide inside the container 24.

The container 24 also comprises inside it a thruster element 29, able to thrust the garment 11 present on the bottom of the container 24 between the vise that is determined between the conveyor belt 12 and the first panel 18.

The device according to the present invention as described heretofore functions as follows.

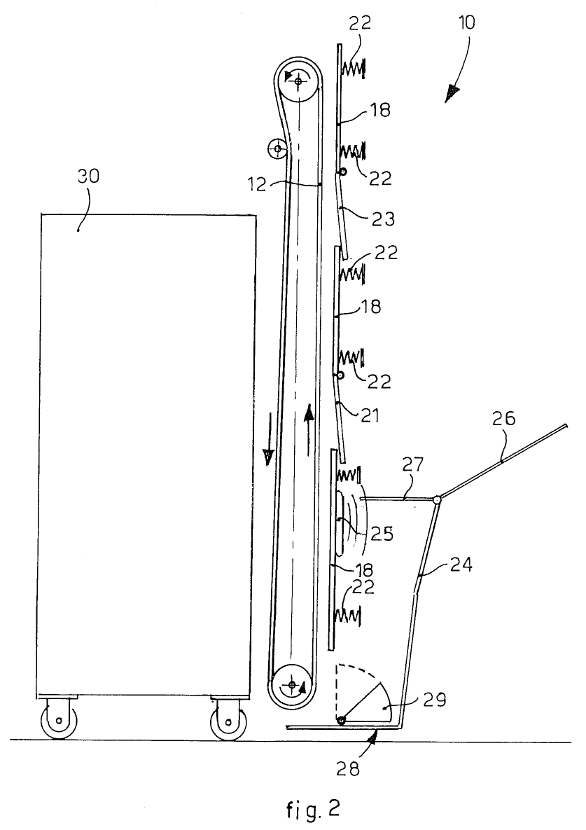

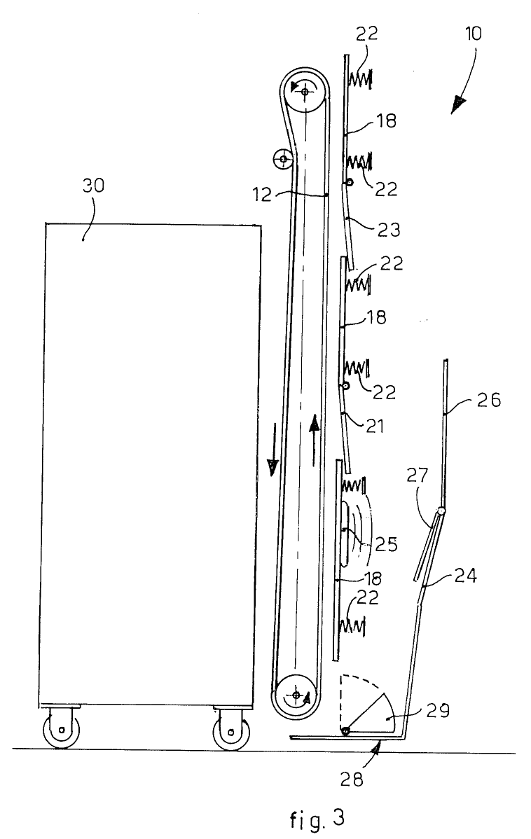

The garment 11 is introduced into the device 10 by opening the inlet door 26 (FIG. 2). The latter, controlled by the automatic safety device, only opens when the feed door 27 is in the horizontal position, so as to guarantee the functionality of the system and safety against accidents. The garment 11 is then rested on the feed door 27, the inlet door 26 is reclosed and the safety device is activated. Subsequently the feed door 27 opens (FIG. 3), making the garment 11 slide inside the container 24 and making it pass for a first time into the field of action of the reading device 25, for a first recognition step. Opening the feed door 27 also activates the movement of the conveyor belt 12.

When it reaches the bottom of the container 24, the garment 11, thrust by the thruster element 29, is taken into the vise consisting of the conveyor belt 12 and the panel 18, so as to be perfectly adherent to the conveyor belt 12, and then transported upward. The sufficiently adherent surface of the conveyor belt 12 prevents the garment from slipping downward.

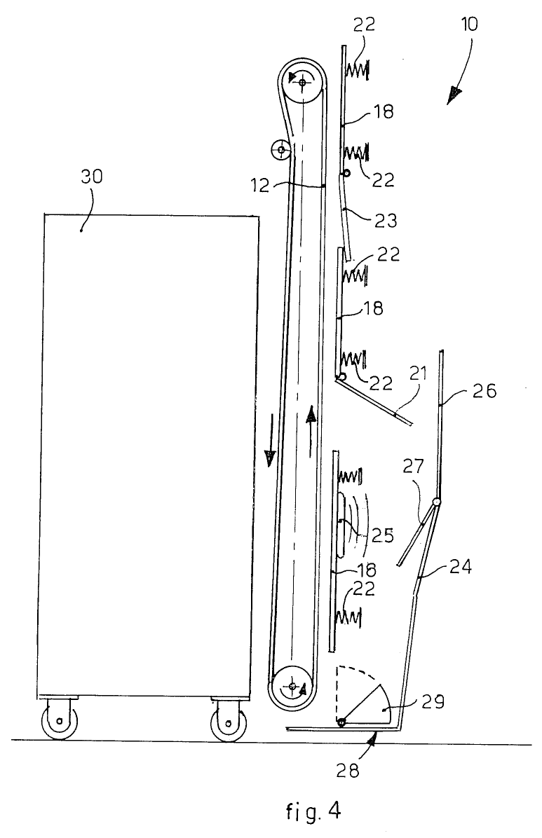

Traveling along the conveyor belt 12, the garment passes for a second time into the field of action of the reading device 25 for another recognition step. If the garment 11 is not recognized, the expulsion door 21 is activated (FIG. 4), which causes the expulsion of the garment from the conveyor belt 12, making it fall back into the container 24. The garment 11 is then again subjected to the previous operations.

When a garment 11 of a particular type is recognized, it will continue its travel along the conveyor belt 12 until it reaches suitable collection containers 30 used to collect the recognized garments, which will then be sent on to subsequent working steps.

Alternatively, the expulsion door 23 may be opened to convey a garment 11 of another type, by means of conveyor means of a known type, into other collection containers, not shown in the drawings.

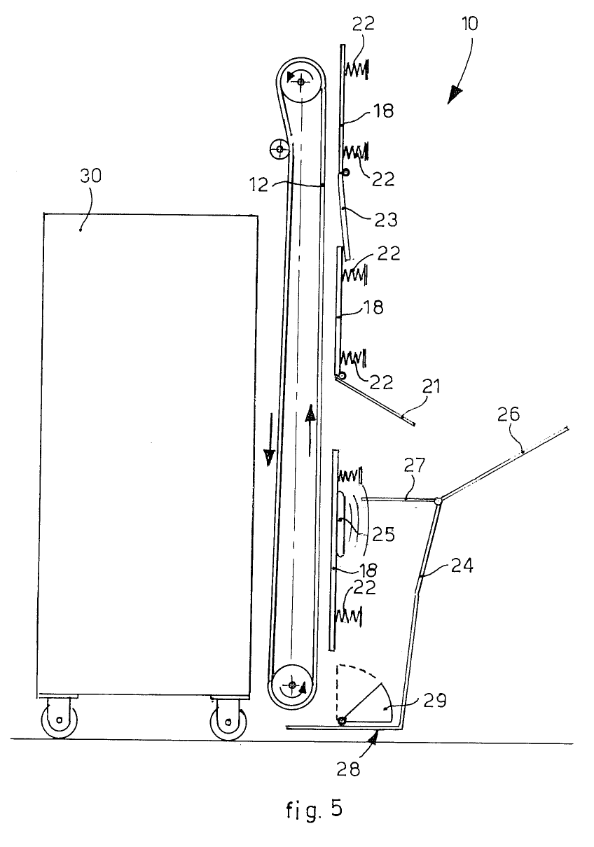

Vice versa, if the garment is again not recognized, the expulsion door 21 is activated (FIG. 5), the feed door 27 is closed, the inlet door 26 is released and the user can take out the garment 11 that has not been recognized.

It is clear that modifications and/or additions of parts may be made to the device for the automatic recognition and sorting of garments as described heretofore, without departing from the field and scope of the present invention.

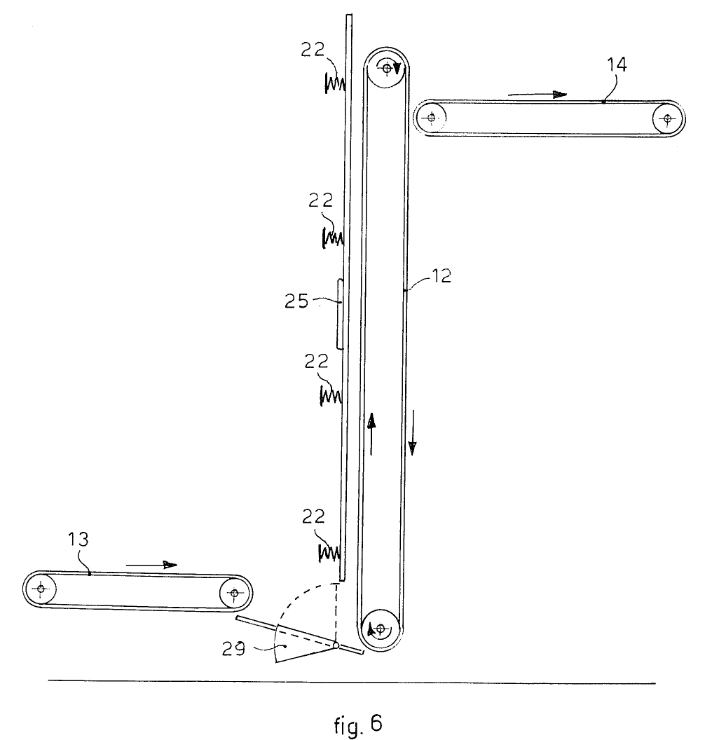

For example, it comes within the field of the present invention to provide to use a conveyor belt 13 to feed the container 24 and another conveyor belt 14 at the upper end of the conveyor belt 12, to transport the recognized garments 11 to subsequent working steps, substantially achieving a transportation of the horizontal-vertical-horizontal type (FIG. 6).

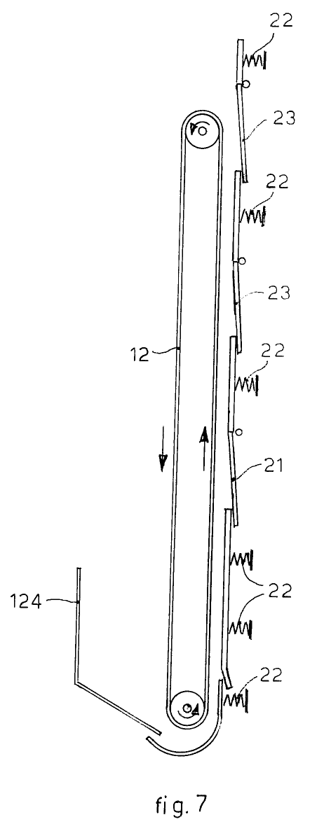

It also comes within the field of the present invention to provide a container 124, disposed in the rear part of the belt, conformed so as to facilitate the introduction of the garment into the vise comprised between the conveyor belt 12 and the panel 18 (FIG. 7).

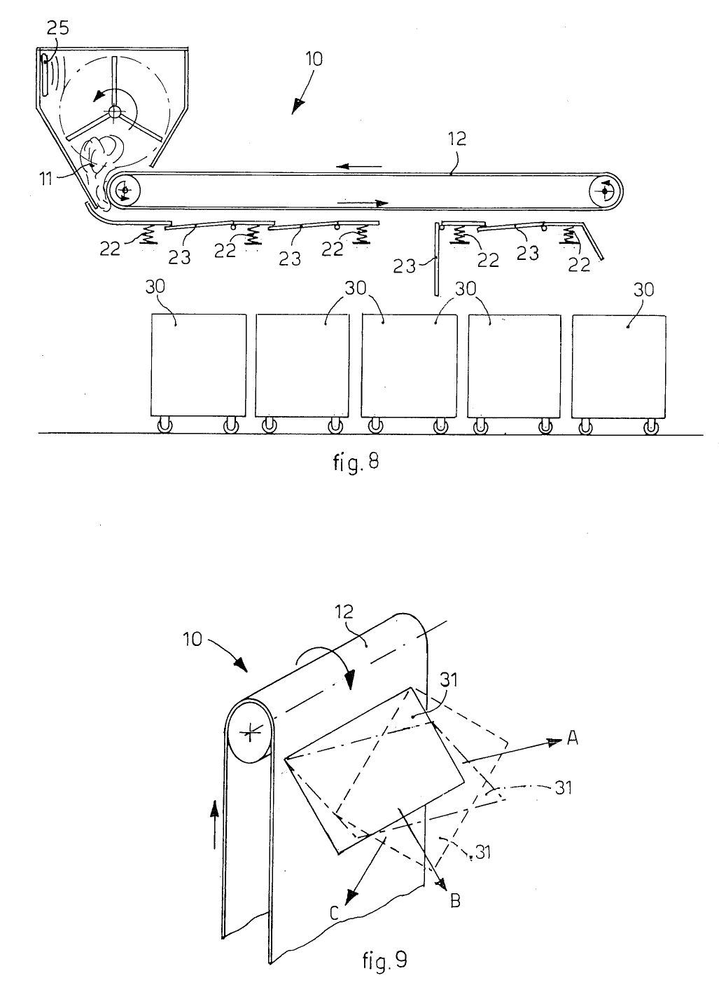

It also comes within the field of the present invention to provide the conveyor belt 12 disposed horizontally and provided with a plurality of expulsion doors 23, the opening of which faces downward, in correspondence with each of which collection containers 30 are disposed, for the collection of the garments 11 selected (FIG. 8).

It also comes within the field of the present invention to provide a sorting device 31 with a variable orientation, disposed in the rear part of the conveyor belt 12, able to sort the garments in different directions A, B or C and into different collection containers 30 (FIG. 9).

According to a variant the sorting device 31 is disposed in the front part of the conveyor belt 12.

It is also clear that, although the present invention has been described with reference to some specific examples, a person of skill in the art shall certainly be able to achieve many other equivalent forms of device for the automatic recognition and sorting of garments, having the characteristics as set forth in the claims and hence all coming within the field of protection defined thereby.

1. A device for the automatic recognition and sorting of garments comprising: identification elements associated with said garments; a container to collect at least one of said garments; recognition elements able to recognize said identification elements; movement means able to transport said garments from said container toward subsequent working steps; mobile contrast means able to cooperate with said garments so as to keep said garments associated with said movement means.

2. The device as in claim 1, comprising expulsion means, associated with said mobile contrast means, able to allow to remove said garments from said movement means.

3. The device as in claim 2, comprising elastic means associated with said movement means and with said mobile contrast means, able to influence said mobile contrast means elastically, so as to allow the movement of said mobile contrast means.

4. The device as in claim 3, comprising thrust means associated with said container, able to thrust said garments between said movement means and said mobile contrast means.

5. The device as in claim 1, wherein said movement means comprises a conveyor belt.

6. The device as in claim 5, wherein said conveyor belt is disposed vertically with respect to said container.

7. The device as in claim 6, wherein said conveyor belt is provided with a sufficiently adherent surface.

8. The device as in claim 7, wherein said mobile contrast means comprise panels.

9. The device as in claim 8, wherein said expulsion means comprise one or more doors pivoted on said panels.

10. The device as in claim 9, comprising actuation means able to command the closing and opening of said doors.

11. The device as in claim 1, comprising sorting means with variable orientation able to sort said garments in different directions (A, B, C).
